(19) United States
(12) Patent Application Publication
(10) Pub. No.: US 2026/0268181 A1
(43) Pub. Date: Sep. 10, 2026

(54) INFORMATION PROCESSING APPARATUS

(71) Applicant: NEC Corporation, Tokyo (JP)

(72) Inventors: Ryuta MATSUNO, Tokyo (JP); Keita SAKUMA, Tokyo (JP); Masakazu HIROKAWA, Tokyo (JP)

(73) Assignee: NEC Corporation, Tokyo (JP)

(21) Appl. No.: 19/549,212

(22) Filed: Feb. 25, 2026

(30) Foreign Application Priority Data
Mar. 5, 2025 (JP) 2025-034483

(51) Int. Cl. G06N 5/043

(52) U.S. Cl. CPC G06N 5/043

(57) ABSTRACT

An information processing apparatus according to the present disclosure includes an acquisition unit that acquires a set of models that predict objective variables at certain different periods ahead from an explanatory variable and a selection unit that selects a group of the models, based on a change in each predicted value using each of the models from a predetermined explanatory variable, in the group of the models respectively related to the certain periods ahead. This enables smooth forecasts generated by machine learning to support reliable decision making.

### INCORPORATION OF BASIC APPLICATION

The present invention is based upon and claims the benefit of the priority of Japanese Patent Application No. 2025-034483 filed on Mar. 5, 2025 in Japan, the disclosure of which is incorporated herein in its entirety by reference.

### TECHNICAL FIELD

The present disclosure relates to an information processing apparatus.

### BACKGROUND ART

A future value to be an objective variable is predicted from time-series data to be an explanatory variable, using a machine learning model. For example, PTL 1 describes that quality of a manufactured object is predicted from time-series data such as a manufacturing condition, using a model. PTL 1 describes that a plurality of models is generated and a model to be used is selected.
PTL 1: WO 2023/243232 A1

### SUMMARY

However, PTL 1 does not describe using a plurality of models in prediction from time-series data and does not mention selecting the plurality of models. Therefore, there is a problem that there is no means for selecting an appropriate combination of the plurality of models, in a situation where the plurality of models is used.

Therefore, an object of the present disclosure is to solve the above problem that it is difficult to select an appropriate combination of a plurality of models, in a situation where the plurality of models is used.

An information processing apparatus according to one aspect of the present disclosure has a configuration including
an acquisition unit that acquires a set of models that predict objective variables at certain different periods ahead from an explanatory variable and
a selection unit that selects a group of the models, based on a change in each predicted value using each of the models from a predetermined explanatory variable, in each group of the models respectively related to the certain periods ahead.

An information processing method according to one aspect of the present disclosure performed by an information processing apparatus, has a configuration including
acquiring a set of models that predict objective variables at certain different periods ahead from an explanatory variable and
selecting a group of the models, based on a change in each predicted value using each of the models from a predetermined explanatory variable, in each group of the models respectively related to the certain periods ahead.

A program according to one aspect of the present disclosure has a configuration for causing an information processing apparatus to execute processing for
acquiring a set of models that predict objective variables at certain different periods ahead from an explanatory variable and
selecting a group of the models, based on a change in each predicted value using each of the models from a predetermined explanatory variable, in each group of the models respectively related to the certain periods ahead.

With the above configuration, the present disclosure can select an appropriate combination of a plurality of models.

### BRIEF DESCRIPTION OF THE DRAWINGS

FIG. 1 is a block diagram illustrating an example of a configuration of an information processing apparatus according to the present disclosure;

FIG. 2 is a flowchart illustrating an example of a processing operation of the information processing apparatus according to the present disclosure;

FIG. 3 is a diagram illustrating an example of processing of the information processing apparatus according to the present disclosure;

FIG. 4 is a diagram illustrating an example of the processing of the information processing apparatus according to the present disclosure;

FIG. 5 is a diagram illustrating an example of the processing of the information processing apparatus according to the present disclosure;

FIG. 6 is a diagram illustrating an example of the processing of the information processing apparatus according to the present disclosure;

FIG. 7 is a block diagram illustrating an example of a hardware configuration of the information processing apparatus according to the present disclosure;

FIG. 8 is a block diagram illustrating an example of the configuration of the information processing apparatus according to the present disclosure; and

FIG. 9 is a flowchart illustrating an example of the processing operation of the information processing apparatus according to the present disclosure.

### EXAMPLE EMBODIMENT

### First Example Embodiment

A first example embodiment of the present disclosure will be described with reference to the drawings. The drawings may relate to any example embodiment.

An information processing apparatus 10 according to the present disclosure is used to select a group of machine learning models respectively related to certain periods ahead, in a case where the plurality of machine learning models that predicts objective variables at certain different periods ahead to be predicted from an explanatory variable is prepared for each certain period ahead. As an example, the information processing apparatus 10 is used to select a group of machine learning models related to each date, in a case where a machine learning model is prepared that predicts a discharge probability of each date to be each of the plurality of certain periods ahead as the objective variable from the explanatory variable such as biological information of a patient or the like.

However, the information processing apparatus 10 according to the present disclosure is not limited to selecting the group of machine learning models that predicts the discharge probability of the patient and may be used to select a group of machine learning models that performs any prediction. For example, the information processing apparatus 10 may be used to select a group of machine learning models used in a case of predicting a state of a patient, a case of predicting quality of a manufactured product, a case of predicting an order quantity of a material, a case of predicting a price of a material, or the like.

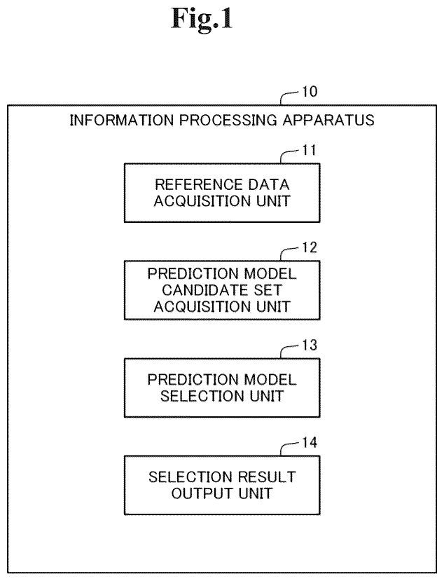

Hereinafter, examples of a configuration and an operation of the information processing apparatus 10 according to the present example embodiment will be described. The information processing apparatus 10 is configured with one or a plurality of information processing apparatuses including arithmetic devices and storage devices. Then, as illustrated in FIG. 1, the information processing apparatus 10 includes a reference data acquisition unit 11, a prediction model candidate set acquisition unit 12, a prediction model selection unit 13, and a selection result output unit 14. Each of functions of the reference data acquisition unit 11, the prediction model candidate set acquisition unit 12, the prediction model selection unit 13, and the selection result output unit 14 can be achieved by the arithmetic device executing a program for achieving each function stored in the storage device.

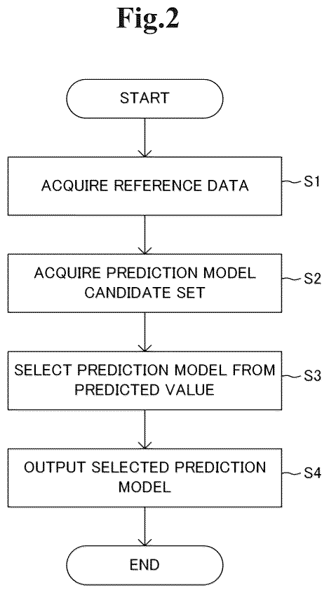

The reference data acquisition unit 11 acquires a column of reference data (step S1 in FIG. 2). As the reference data column, a column of explanatory variables (x₁, x₂, . . . , x_{N}) arranged in a time axis order is acquired. The reference x₁ indicates oldest data, and the reference x_{N} indicates data at the newest time. At this time, the reference data acquisition unit 11 may acquire an objective variable related to the explanatory variable, in addition to the explanatory variable. For example, a column in which pairs of the explanatory variables and the objective variables such as ((x₁, y₁), (x₂, y₂), . . . , (xₙ, yₙ)) are arranged in the time axis order may be acquired as the reference data.

The prediction model candidate set acquisition unit 12 acquires a candidate set of prediction models that predict a plurality of different predetermined periods ahead (step S2 in FIG. 2). For example, in a case where the plurality of predetermined periods ahead is set as one step ahead to T steps ahead (T is positive integer), a candidate set of T prediction models that predict the one step ahead to the T steps ahead is acquired. At this time, in a case where the candidate set of the prediction model is expressed as Expression 1, a prediction model for t steps ahead includes a set of nₜ prediction models indicated in Expression 2. That is, there is a plurality of candidates of a prediction model fₜ related to each step ahead, and these candidates exist in relation to the plurality of steps to form a set. In the present example embodiment, from the candidate set of the prediction model as described above, one prediction model (group of prediction model) is selected from each step ahead, that is, each of F₁, . . . , F_{T}, as described below.

$$\{ {ℱ}_{1} , … , {ℱ}_{T} \} \qquad [ Expression 1 ]$$

$${ℱ}_{t} = \{ {f}_{t}^{( 1 )} , … , {f}_{t}^{( {n}_{t} )} \} \qquad [ Expression 2 ]$$

The prediction model selection unit 13 sets a group of the prediction models represented by Expression 3 obtained by extracting one prediction model for each of the one step ahead to the T steps ahead, from the candidate set of the prediction model. At this time, the plurality of groups of prediction models is set. For example, groups of the prediction models for all possible combinations are set.

$$( {f}_{1} , … , {f}_{T} ) \qquad [ Expression 3 ]$$

Then, the prediction model selection unit 13 performs prediction using each prediction model from the explanatory variable, for each set group of prediction models and selects a group of prediction models based on a change in each predicted value (step S3 in FIG. 2). At this time, the prediction model selection unit 13 evaluates a smoothness of the change in each predicted value as an evaluation index and selects a group of prediction models of which each predicted value smoothly changes. Specifically, the prediction model selection unit 13 selects the group of prediction models, using both or one of a first evaluation index J₁ (first variable) and a second evaluation index J₂ (second variable) to be described below.

Here, the first evaluation index J₁ is a smoothness of the change in each predicted value using each prediction model related to each of the plurality of steps ahead from the explanatory variable at the same time. That is, the prediction model selection unit 13 evaluates a smoothness of each predicted value up to T steps ahead indicated in Expression 4, based on an explanatory variable xₜ at a certain time t.

$$( {f}_{1} ( {x}_{t} ) , {f}_{2} ( {x}_{t} ) , … , {f}_{T} ( {x}_{t} ) ) \qquad [ Expression 4 ]$$

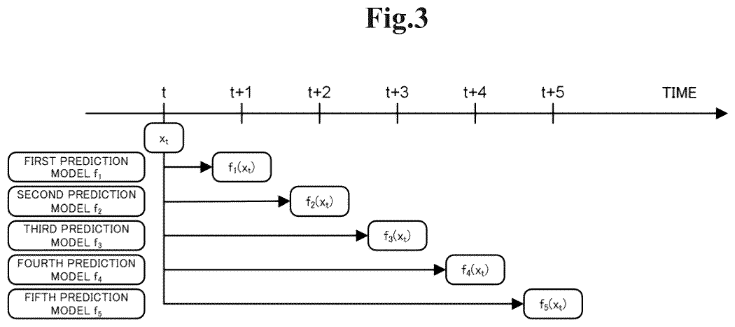

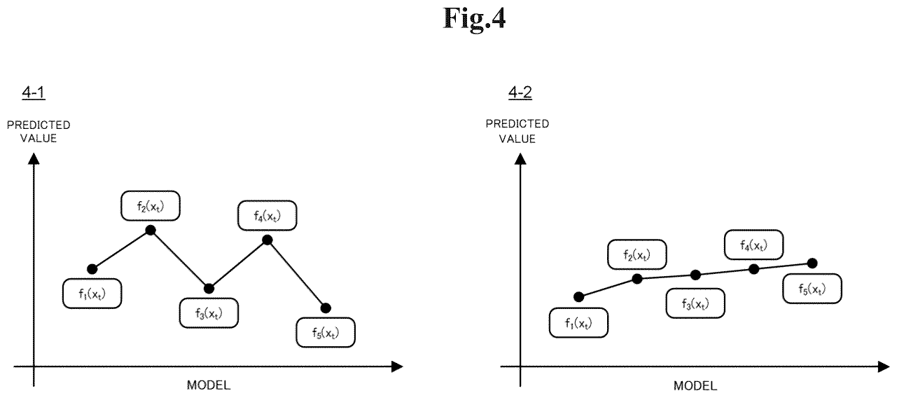

FIG. 3 illustrates an example of prediction by the prediction model when the first evaluation index J₁ is evaluated. In this example, at a current time t, a first prediction model f₁ related to a prediction model at one step ahead predicts a predicted value f₁(x₁) at a time t+1 that is the one step ahead, a second prediction model f₂ related to a prediction model at two steps ahead predicts a predicted value f₂(x₂) at a time t+2, that is, two steps ahead, and predicted values f₅(x₅) up to five steps ahead are similarly predicted, and it is assumed that five predicted values as illustrated in FIG. 4(4-1) be obtained. At this time, in a case where the five predicted values greatly change upward/downward as illustrated in FIG. 4(4-1), it is difficult to interpret entire tendency of the predicted values, and it is difficult to make long-term decision based on the prediction. For example, in material price prediction, it is difficult to make a material procurement plan if rising and falling trends are unknown. As an example, since the material procurement is carried out in a medium and long term, trend prediction is as important as accurate pinpoint prediction. Therefore, as illustrated in FIG. 4(4-2), regarding the first evaluation index J₁, it is assumed to give good evaluation in a case where the predicted value smoothly changes. Then, the prediction evaluation described above is repeatedly executed as time advances, and a group of prediction models to have good evaluation is selected.

Specifically, as indicated in Expression 5, the prediction model selection unit 13 may evaluate the first evaluation index J₁, based on a square of a second order backward difference. The reference Wᵢ represents an evaluation weight.

$${J}_{1} = \frac{1}{N} {\sum }_{t = 1}^{N} \frac{1}{T - 2} {\sum }_{i = 3}^{T} {{w}_{i} ( {f}_{i} ( {x}_{t} ) - 2 {f}_{i - 1} ( {x}_{t} ) + {f}_{i - 2} ( {x}_{t} ) )}^{2} \qquad [ Expression 5 ]$$

In the above Expression 5, the first evaluation index J₁ indicates a non-smoothness degree of the predicted value, that is, a degree of non-smoothness and has a smaller value and better evaluation as the smoothness, that is, a smoothness degree is higher. Therefore, the prediction model selection unit 13 selects a group of prediction models that minimizes the first evaluation index J₁.

Here, the prediction model selection unit 13 may change the evaluation weight Wᵢ in Expression 5, according to a length of a period up to a certain period ahead to be predicted. For example, in a case where it is better that the predicted value is smoother, as the future prediction, that is, a period up to a time to be predicted is longer, the evaluation weight Wᵢ may be increased according to i. In this case, the group of prediction models is selected so that recent prediction of which the period to be predicted is close is relatively emphasized on accuracy, and future prediction of which the period is far is relatively emphasized on the smoothness.

The second evaluation index J₂ is a smoothness of a change in each predicted value using each prediction model related to each of a plurality of steps ahead for the same time from the plurality of times. Specifically, since an objective variable yₜ that is a predicted value for the certain time t is predicted T times until the time t comes, that is, T times from a time (t−T) to a time (t−1), a smoothness of T times of predicted values indicated in Expression 6 is evaluated.

$${f}_{T} ( {x}_{t - T} ) , … , {f}_{1} ( {x}_{t - 1} ) \qquad [ Expression 6 ]$$

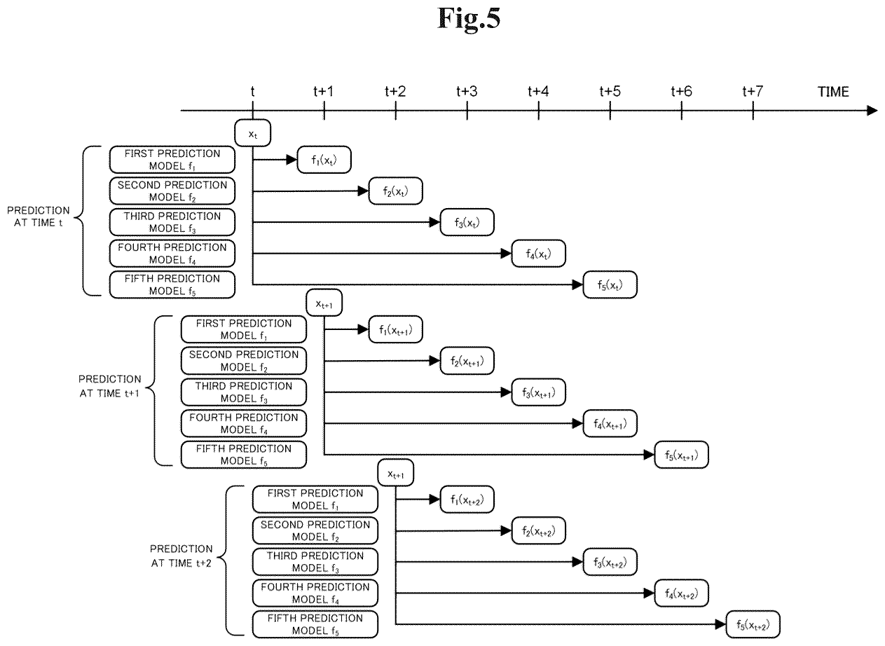

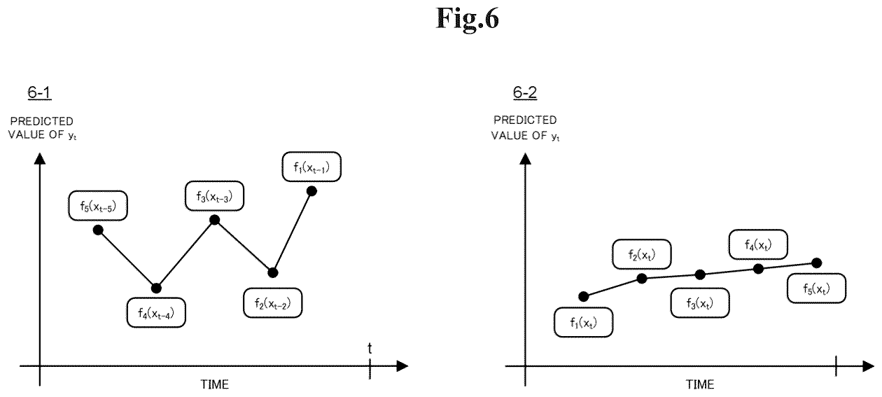

FIG. 5 illustrates an example of prediction by the prediction model when the second evaluation index J₂ is evaluated. In this example, it is assumed that predicted values f₁(xₜ) to f₅(xₜ) at times t to t+5 that are 1 to 5 steps ahead at the time t, predicted values f₁(xₜ₊₁) to f₅(xₜ₊₆) at times t+1 to t+6 that are 1 to 5 steps ahead at the time t+1, and predicted values f₁(xₜ₊₂) to f₅(xₜ₊₇) at times t+2 to t+7 that are 1 to 5 steps ahead at the time t+2 be obtained. If tracing back by 5 steps from the time t, since the objective variable yₜ that is the predicted value for the time t is predicted 5 times from a time (t−5) to a time (t−1) from 5 steps before to the time t, a smoothness of the predicted values of 5 times is evaluated. At this time, in a case where the predicted values of 5 times greatly change upward and downward as illustrated in FIG. 6(6-1), the predicted value is not consistent, and it is difficult to create a plan at the time of long-term decision making based on the prediction. For example, in a case where it is predicted that an objective variable (f₂(xₜ₋₂)) at the time t decreases at the time t−2, if an objective variable (f₂(xₜ₋₁)) at the time t suddenly increases at the time t−1, an action scheduled at the time t−2 may be adversely affected. As an example, in material price prediction, it is necessary to suddenly change a procurement plan at the time when the price is low. Therefore, as illustrated in FIG. 6(6-2), regarding the second evaluation index J₂, it is assumed to give good evaluation in a case where the predicted value smoothly changes and a matching degree is high. Then, the prediction evaluation described above is repeatedly executed as time advances, and the group of prediction models to have good evaluation is selected.

Specifically, the prediction model selection unit 13 may evaluate the smoothness based on a square of a first order backward difference, as indicated in Expression 7. The reference Wᵢ represents the evaluation weight.

$${J}_{2} = \frac{1}{N - 1} {\sum }_{t = 2}^{N} \frac{1}{T - 1} {\sum }_{i = 2}^{T} {{w}_{i} ( {f}_{i} ( {x}_{t} ) - {f}_{i - 1} ( {x}_{t + 1} ) )}^{2} \qquad [ Expression 7 ]$$

In Expression 7 described above, the second evaluation index J₂ represents the matching degree of the predicted value, and as the smoothness is higher, that is, the matching degree is higher, the second evaluation index J₂ becomes smaller, and good evaluation is made. Therefore, the prediction model selection unit 13 selects a group of prediction models that minimizes the second evaluation index J₂.

Here, the prediction model selection unit 13 may change the evaluation weight Wᵢ in Expression 7, according to a length of a period up to a certain period ahead to be predicted. For example, in a case where it is desired to maintain consistency of the predicted value, as the recent prediction, that is, a period up to the time to be predicted is shorter, the evaluation weight Wᵢ may be increased when i is small.

As described above, the prediction model selection unit 13 selects the group of prediction models that minimizes the value, using both or one of the first evaluation index J₁ and the second evaluation index J₂. The prediction model selection unit 13 may select the group of prediction models in such a way as to improve a prediction performance of the group of prediction models, that is, to reduce a prediction error L. Specifically, the prediction model selection unit 13 may select the group of prediction models, in such a way as to minimize a value obtained by adding the first evaluation index J₁ and the second evaluation index J₂ to the prediction error L (third variable) with weights, that is, by solving a minimization problem in Expression 8.

$${min}_{{f}_{1} ∈ {ℱ}_{1} , … , {f}_{T} ∈ {ℱ}_{T}} L + α {J}_{1} + β {J}_{2} \qquad [ Expression 8 ]$$

At this time, the prediction error L may be defined as indicated in Expression 9, using a loss function 1. As the loss function 1, a square error, an absolute error, a percent error, or the like may be used.

$$L = \frac{1}{N} {\sum }_{t = 1}^{N} \frac{1}{T} {\sum }_{i = 1}^{T} ℓ ( {f}_{i} ( {x}_{t} ) , {y}_{t + i} ) \qquad [ Expression 9 ]$$

In a case where the group of prediction models that improves the prediction performance using the prediction error L is selected, the reference data acquisition unit 11 needs to acquire a pair of the explanatory variable and the objective variable.

The selection result output unit 14 outputs a selection result of the group of prediction models. For example, the selection result output unit 14 outputs information for specifying the selected group of prediction models. At this time, as illustrated in FIGS. 4 and 6, the selection result output unit 14 may output an example of the predicted value by the selected group of prediction models, to be displayed. For example, a graph may be output that represents a change in the predicted values at the plurality of times when the explanatory variable at the same time is input to the selected group of prediction models or a change in the predicted values at the same time when the explanatory variables at the plurality of times are input.

As described above, in the present disclosure, among the prediction models that predict the certain periods ahead, the group of prediction models that smooths the change in the predicted value is selected. This makes it possible to select an appropriate combination of a plurality of models with no deviation in prediction.

### Second Example Embodiment

Next, a second example embodiment of the present disclosure will be described. An information processing apparatus 10 according to the present example embodiment has a configuration similar to that of the first example embodiment. Then, the present example embodiment is applicable to the following tasks.

The task in the present example embodiment is to select a group of prediction models (f₁, . . . , f₃₀) that predicts an output from the following inputs.
Input: Biological information obtained by sensing a blood pressure, a heart rate, a blood oxygen concentration, or the like, in addition to an age, a sex, a height, a weight, an occupation, a blood type, a medical history, genetic information, and electronic medical record information of a patient who is currently in a hospital
Output: Discharge probability of a patient from one day to 30 days ahead
Then, by using the selected group of prediction models, a period when hospital beds are vacant is estimated, a reservation system is adjusted, and work management of doctors and nurses is created.

In a case where the prediction model is selected only based on the prediction performance, the prediction is not smooth, and it is difficult to determine whether the patient tends to recover on average (discharge probability gradually increases) or the patient tends to deteriorate (discharge probability gradually decreases), and it is difficult to make a decision in hospital bed management (when new patient is accepted, create shift of each nurse). For example, there is a possibility that the prediction changes from day to day (for example, prediction made yesterday and prediction made today for a predetermined number of days ahead are different) and the decision made yesterday is reversed today.

On the other hand, in the present example embodiment, as described in the first example embodiment, in the above task, the group of prediction models is selected in such a way that a change in the discharge probabilities on the plurality of days ahead when biological information (explanatory variable) of the patient at the same date is input and a change in the discharge probability on the same day when the pieces of biological information (explanatory variable) of the patient on the plurality of days are input become smooth. As a result, since the prediction of the plurality of days ahead by the prediction model becomes smooth, and it is easy to find the recovery tendency of the patient, it is easy to grasp whether the hospital bed will/will not be vacant in the future, and it is easy to perform the hospital bed management. Since the daily prediction by the prediction model is consistent, it is possible to make a decision with a sense of security.

### Third Example Embodiment

Next, a third example embodiment of the present disclosure will be described with reference to the drawings. In the present example embodiment, an outline of the information processing apparatuses and the like described in the above-described example embodiments will be illustrated. The drawings may relate to any example embodiment.

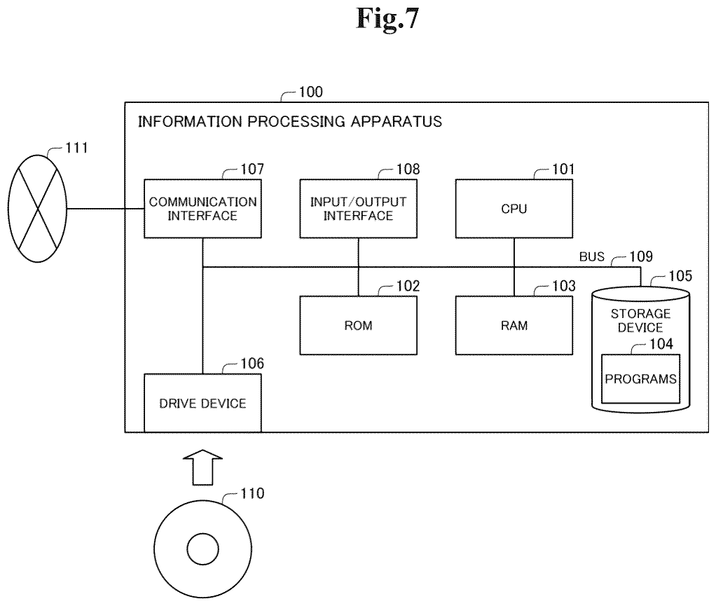

First, a hardware configuration of an information processing apparatus 100 in the present disclosure will be described. The information processing apparatus 100 is constituted by a general information processing apparatus and has the following hardware configuration, as illustrated in FIG. 7, as an example.
A central processing unit (CPU) 101 (arithmetic device)
A read only memory (ROM) 102 (storage device)
A random access memory (RAM) 103 (storage device)
Programs 104 to be loaded into the RAM 103
A storage device 105 that stores the programs 104
A drive device 106 that performs reading and writing on a storage medium 110 outside the information processing apparatus
A communication interface 107 connected to a communication network 111 outside the information processing apparatus
An input/output interface 108 that inputs and outputs data
A bus 109 that connects each component

FIG. 7 illustrates an example of the hardware configuration of the information processing apparatus that is the information processing apparatus 100, and the hardware configuration of the information processing apparatus is not limited to the above-described case. For example, the information processing apparatus may be constituted by a part of the above-described configuration such as not including the drive device 106. The information processing apparatus can use, instead of the above-described CPU, a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like.

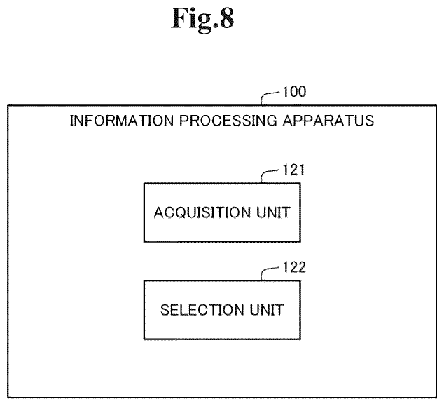

Then, an acquisition unit 121 and a selection unit 122 illustrated in FIG. 8 can be constructed and equipped in the information processing apparatus 100 by the CPU 101 acquiring and executing the programs 104. The programs 104 are stored in, for example, the storage device 105 or the ROM 102 in advance, and the CPU 101 loads and executes the programs 104 on the RAM 103, as necessary. The programs 104 may be supplied to the CPU 101 via the communication network 111, or the programs 104 may be stored in the storage medium 110 in advance and the drive device 106 may read the programs 104 and supply the read programs 104 to the CPU 101. However, the above-described acquisition unit 121 and selection unit 122 may be constructed by a dedicated electronic circuit for achieving the means.

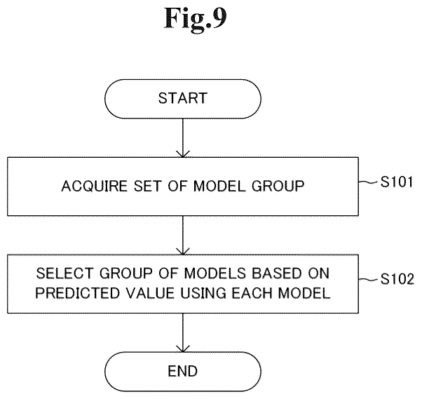

The acquisition unit 121 acquires a set of models that respectively predict objective variable at certain different periods ahead, from an explanatory variable (step S101 in FIG. 9). The selection unit 122 selects a group of the models, based on a change in each predicted value using each model from a predetermined explanatory variable, in each group of models related to each of the certain periods ahead (step S102 in FIG. 9).

In the configuration, first, the information processing apparatus 100 acquires the set of models that respectively predict the predicted values at the certain different periods ahead. Then, the information processing apparatus 100 selects the group of models based on the change in each predicted value, in each group of models. At this time, the information processing apparatus 100 evaluates a smoothness of the change in each predicted value as an evaluation index and selects the group of prediction models of which each predicted value smoothly changes. As an example, the information processing apparatus 100 selects the group of prediction models that smooths the change in each predicted value using each prediction model related to each of the plurality of certain periods ahead, from the explanatory variable at the same time. As an example, the information processing apparatus 100 selects the group of prediction models that smooths the change in each predicted value using each prediction model related to the certain period ahead at the same time from each of the explanatory variables at the plurality of times. This makes it possible to reduce deviation in the prediction and select an appropriate combination of the plurality of models.

At least one or more of the functions of the acquisition unit 121 and the selection unit 122 described above may be executed by an information processing apparatus installed and connected at any place on a network, that is, may be executed on so-called cloud computing.

The above-described programs can be stored using various types of non-transitory computer readable media and supplied to a computer. The non-transitory computer readable media include various types of tangible storage media. Examples of the non-transitory computer readable medium include a magnetic recording medium (for example, flexible disk, magnetic tape, or hard disk drive), an optical magnetic recording medium (for example, magneto-optical disc), a compact disc-read only memory (CD-ROM), a CD-R, a CD-R/W, and a semiconductor memory (for example, mask ROM, programmable ROM (PROM), erasable PROM (EPROM), a flash ROM, or a random access memory (RAM)). The programs may also be supplied to the computer by various types of transitory computer readable media. Examples of the transitory computer readable media include electrical signals, optical signals, and electromagnetic waves. The transitory computer readable media can supply the programs to the computer via a wired communication path such as an electric wire and an optical fiber, or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

### <Supplementary Note>

Some or all of the above example embodiments may also be described as in the following Supplementary Notes. Hereinafter, an outline of configurations of the information processing apparatus, the information processing method, and the program in the present disclosure will be described. However, the present disclosure is not limited to the configurations described in the following Supplementary Notes.

Some or all of the configurations described in Supplementary Notes 2 to 8.2 dependent on Supplementary Note 1 described below and the functions according to those configurations can also be dependent on other Supplementary Notes 9 and 10 by a dependency relationship similar to that of Supplementary Notes 2 to 8.2. Moreover, some or all of the configurations described as the supplementary notes and the functions according to those configurations can be similarly dependent on not only Supplementary Notes 1, 9, and 10, but also various pieces of similar hardware and software, and various types of recording means that record the software, or systems without departing from the above-described example embodiments.

### (Supplementary Note 1)

An information processing apparatus including:
an acquisition unit configured to acquire a set of models that respectively predict objective variables at certain different periods ahead from an explanatory variable; and
a selection unit configured to select a group of the models, based on a change in each predicted value using each of the models from a predetermined explanatory variable, in each group of the models respectively related to the certain periods ahead.

### (Supplementary Note 2)

The information processing apparatus according to supplementary note 1, in which
the selection unit selects the group of models in such a way that the change in each predicted value using each model from the predetermined explanatory variable becomes smoother according to a preset reference, in each group of the models.

### (Supplementary Note 3)

The information processing apparatus according to supplementary note 1, in which
the selection unit selects the group of models, based on the change in each predicted value using each model related to each of a plurality of the certain periods ahead from a same time, in each group of the models.

### (Supplementary Note 4)

The information processing apparatus according to supplementary note 1, in which
the selection unit selects the group of models, based on the change in each predicted value by each model related to each of the plurality of certain periods ahead with respect to the same time from a plurality of times, in each group of the models.

### (Supplementary Note 5)

The information processing apparatus according to supplementary note 3, in which
the selection unit selects the group of models in such a way that a smoothness degree of the change in each predicted value using each model becomes higher.

### (Supplementary Note 6)

The information processing apparatus according to supplementary note 4, in which
the selection unit selects the group of models in such a way that a matching degree of the change in each predicted value using each model becomes higher.

### (Supplementary Note 7)

The information processing apparatus according to supplementary note 1, in which
the selection unit weights the change in each predicted value by each model according to a length of a period at the certain period ahead related to each model and selects the group of models based on a value of the change with the weight.

### (Supplementary Note 8)

The information processing apparatus according to supplementary note 1, in which
the selection unit selects the group of models, based on a difference between each predicted value using each model from the predetermined explanatory variable and an objective variable related to the predetermined explanatory variable, in each group of the models respectively related to the certain periods ahead.

### (Supplementary Note 8.1)

The information processing apparatus according to supplementary note 8, in which
the selection unit selects the group of models in such a way that a sum of a first variable that becomes smaller as a smoothness degree of the change in each of the predicted values using the models respectively related to the plurality of certain periods ahead from the same time is higher and a second variable that becomes smaller as a matching degree indicating the change in each of the predicted values by the models respectively related to the plurality of certain periods ahead with respect to the same time from a plurality of the times is higher, in each group of the models, becomes smaller.

### (Supplementary Note 8.2)

The information processing apparatus according to supplementary note 8.1, in which
the selection unit selects the group of models in such a way that a sum of a third variable indicating an error between each predicted value using each model from the predetermined explanatory variable and an objective variable related to the predetermined explanatory variable, the first variable, and the second variable, in each group of the models, becomes smaller.

### (Supplementary Note 9)

An information processing method performed by an information processing apparatus, the method including:
acquiring a set of models that respectively predict objective variables at certain different periods ahead from an explanatory variable; and
selecting a group of the models, based on a change in each predicted value using each of the models from a predetermined explanatory variable, in each group of the models respectively related to the certain periods ahead.

### (Supplementary Note 10)

A program for causing an information processing apparatus to execute processing for:
acquiring a set of models that respectively predict objective variables at certain different periods ahead from an explanatory variable; and
selecting a group of the models, based on a change in each predicted value using each of the models from a predetermined explanatory variable, in each group of the models respectively related to the certain periods ahead.

### REFERENCE SIGNS LIST

10 information processing apparatus
11 reference data acquisition unit
12 prediction model candidate set acquisition unit
13 prediction model selection unit
14 selection result output unit
100 information processing apparatus
101 CPU
102 ROM
103 RAM
104 programs
105 storage device
106 drive device
107 communication interface
108 input/output interface
109 bus
110 storage medium
111 communication network
121 acquisition unit
122 selection unit

1. An information processing apparatus comprising:
at least one memory configured to store processing instructions; and
at least one processor configured to execute the processing instructions to:
acquire a set of models that respectively predict objective variables at certain different periods ahead from an explanatory variable; and
select a group of the models, based on a change in each predicted value using each of the models from a predetermined explanatory variable, in each group of the models respectively related to the certain periods ahead.

2. The information processing apparatus according to claim 1, wherein
the at least one processor is configured to execute the processing instructions to select the group of models in such a way that the change in each predicted value using each model from the predetermined explanatory variable becomes smoother according to a preset reference, in each group of the models.

3. The information processing apparatus according to claim 1, wherein
the at least one processor is configured to execute the processing instructions to select the group of models, based on the change in each predicted value using each model related to each of a plurality of the certain periods ahead from a same time, in each group of the models.

4. The information processing apparatus according to claim 1, wherein
the at least one processor is configured to execute the processing instructions to select the group of models, based on the change in each predicted value by each model related to each of a plurality of the certain periods ahead with respect to the same time from a plurality of times, in each group of the models.

5. The information processing apparatus according to claim 3, wherein
the at least one processor is configured to execute the processing instructions to select the group of models in such a way that a smoothness degree of the change in each predicted value using each model becomes higher.

6. The information processing apparatus according to claim 4, wherein
the at least one processor is configured to execute the processing instructions to select the group of models in such a way that a matching degree of the change in each predicted value using each model becomes higher.

7. The information processing apparatus according to claim 1, wherein
the at least one processor is configured to execute the processing instructions to weight the change in each predicted value by each model according to a length of a period at the certain period ahead related to each model and select the group of models based on a value of the change with the weight.

8. The information processing apparatus according to claim 1, wherein
the at least one processor is configured to execute the processing instructions to select the group of models, based on a difference between each predicted value using each model from the predetermined explanatory variable and an objective variable related to the predetermined explanatory variable, in each group of the models respectively related to the certain periods ahead.

9. The information processing apparatus according to claim 8, wherein
the at least one processor is configured to execute the processing instructions to select the group of models in such a way that a sum of a first variable that becomes smaller as a smoothness degree of the change in each of the predicted values using the models respectively related to the plurality of certain periods ahead from the same time is higher and a second variable that becomes smaller as a matching degree indicating the change in each of the predicted values by the models respectively related to the plurality of certain periods ahead with respect to the same time from a plurality of the times is higher, in each group of the models, becomes smaller.

10. The information processing apparatus according to claim 9, wherein
the at least one processor is configured to execute the processing instructions to select the group of models in such a way that a sum of a third variable indicating an error between each predicted value using each model from the predetermined explanatory variable and an objective variable related to the predetermined explanatory variable, the first variable, and the second variable, in each group of the models, becomes smaller.

11. An information processing method performed by an information processing apparatus, the method comprising:
acquiring a set of models that respectively predict objective variables at certain different periods ahead from an explanatory variable; and
selecting a group of the models, based on a change in each predicted value using each of the models from a predetermined explanatory variable, in each group of the models respectively related to the certain periods ahead.

12. The information processing method according to claim 11, wherein
the information processing apparatus
selects the group of models in such a way that the change in each predicted value using each model from the predetermined explanatory variable becomes smoother according to a preset reference, in each group of the models.

13. The information processing method according to claim 11, wherein
the information processing apparatus
selects the group of models, based on the change in each predicted value using each model related to each of a plurality of the certain periods ahead from a same time, in each group of the models.

14. The information processing method according to claim 11, wherein
the information processing apparatus
selects the group of models, based on the change in each predicted value by each model related to each of a plurality of the certain periods ahead with respect to the same time from a plurality of times, in each group of the models.

15. The information processing method according to claim 13, wherein
the information processing apparatus
selects the group of models in such a way that a smoothness degree of the change in each predicted value using each model becomes higher.

16. The information processing method according to claim 14, wherein
the information processing apparatus
selects the group of models in such a way that a matching degree of the change in each predicted value using each model becomes higher.

17. The information processing method according to claim 11, wherein
the information processing apparatus
weights the change in each predicted value by each model according to a length of a period at the certain period ahead related to each model and selects the group of models based on a value of the change with the weight.

18. The information processing method according to claim 11, wherein
the information processing apparatus
selects the group of models, based on a difference between each predicted value using each model from the predetermined explanatory variable and an objective variable related to the predetermined explanatory variable, in each group of the models respectively related to the certain periods ahead.

19. A non-transitory computer-readable storage medium storing a program for causing an information processing apparatus to execute processing for:
acquiring a set of models that respectively predict objective variables at certain different periods ahead from an explanatory variable; and
selecting a group of the models, based on a change in each predicted value using each of the models from a predetermined explanatory variable, in each group of the models respectively related to the certain periods ahead.
